(19) United States
(12) Patent Application Publication
(10) Pub. No.: US 2008/0021602 A1
(43) Pub. Date: Jan. 24, 2008

(54) Electrically Powered Rail Propulsion Vehicle and Method

(75) Inventors: John R. Kingham, Yardley, PA (US); Thomas L. Bartley, San Diego, CA (US); Paul E. Kaufmann, Bernardsville, NJ (US)

Correspondence Address: PROCOPIO, CORY, HARGREAVES & SAVITCH LLP, 530 B STREET, SUITE 2100, SAN DIEGO, CA, 92101, US

(73) Assignee: ISE CORPORATION, Poway, CA (US)

(21) Appl. No.: 11/849,190

(22) Filed: Aug. 31, 2007

Related U.S. Application Data
(63) Continuation-in-part of application No. 11/467,038, filed on Aug. 24, 2006.
(63) Continuation-in-part of application No. 11/420,064, filed on May 24, 2006.

(51) Int. Cl. G05D 1/00; B61C 3/00; H02J 7/00; H02K 7/02

(52) U.S. Cl. 701/19; 105/49; 180/165; 320/167

(57) ABSTRACT

A method of bridging a gap in an external electrical power supply line without stalling using an electrically powered rail propulsion vehicle includes using an electrically powered rail propulsion vehicle to propel a consist, the electrically powered rail propulsion vehicle configured to run as an emission-free pure electric unit from the external electrical power supply line; determining if a gap in the external electrical power supply line condition occurs; and supplying electric power from one or more ultracapacitor packs to run the electrically powered rail propulsion vehicle if a gap condition is determined to occur.

### CROSS-REFERENCE AND RELATED APPLICATION

This application is a continuation-in-part of U.S. patent application Ser. No. 11/467,038, filed Aug. 24, 2006, which is a continuation-in-part of U.S. patent application Ser. No. 11/420,064, filed May 24, 2006. This application claims the benefit of these prior applications, and these prior applications are incorporated by reference herein as though set forth in full.

### FIELD OF THE INVENTION

The field of the invention relates to electrically powered rail propulsion vehicles such as dual-mode locomotives, electric street cars, and electrically powered light rail commuter cars.

### BACKGROUND OF INVENTION

A dual-mode locomotive is capable of running as an emission-free pure electric unit from an external electric traction power source (e.g., a third rail) or, when in non-electrified territory, as a conventional diesel unit. However, if the power pickup is from a third rail, the dual-mode locomotive has the major drawback that it is subject to stalling when it traverses conductor-rail gaps (i.e., when “gap jumping”).

Moreover, “gapping” is inevitable in any third rail system. For the most part conductor-rail gaps are relatively short, such as can occur at substations when traveling from one traction power feeder section to another. These gaps are commonly referred to as “gaplets”, having a length typically less than the shoe span of a dual-mode locomotive. As such, gaplets do not present a traction problem.

However, in the vicinity of a major interlocking, unlike overhead catenary systems, the inevitable discontinuity of the third rail can be an issue. In fact, some breaks can be up to eight-hundred feet long. The avoidance of stalling across a gap may depend upon maintaining adequate speed to coast through the crossover. Under adverse conditions (for example when a 15 mph terminal speed restriction and an ascending grade are taken into account) however, gap stalling is a real concern.

To remedy this problem, short lengths of conductor called “kicker rails” are sometimes used to provide a propulsion boost. However, they are of limited use for a locomotive because there is a reasonably lengthy pre-charge time before the main breaker re-closes and applies power to the traction motors.

Another approach to avoid gap stalling is where dual-mode locomotives are provided at opposite ends of a train of railcars. lacing locomotives on opposite ends of a train of cars may result in substantial additional and unnecessary expense to the operator.

Additionally, in all cases of “gap jumping” if the gap interferes with the flow of current to the inductive load of the electric motors the magnetic energy storage of the inductance will increase the voltage across the gap as necessary to generate an arc through ionized air to keep the current flowing until the stored magnetic energy of the inductor is discharged. These “arcs” are bright enough to light up the night sky and have an eroding effect on the materials of the third rail and the locomotive power pickup.

Accordingly, the present invention is directed toward overcoming the problems associated with “gap jumping”.

### SUMMARY OF THE INVENTION

An aspect of the invention involves a method of bridging a gap in an external electrical power supply line without stalling, using an electrically powered rail propulsion vehicle. The method includes using an electrically powered rail propulsion vehicle to propel a train of cars, the electrically powered rail propulsion vehicle configured to run as an emission-free pure electric unit from the external traction power provided by an external electrical power supply line; determining if a gap in the external electrical power supply line condition occurs; and supplying electric power from one or more ultracapacitor packs to run the electrically powered rail propulsion vehicle if a gap condition is determined to occur. According to one embodiment, the continued flow of current through the electric drive motors now coming from the ultracapacitor packs allows the magnetic energy of the electric drive motor inductance to more slowly discharge as the ultracapacitor discharges. The net effect is that the ultracapacitor pack serves to suppress the “arc” that would otherwise occur. This is particularly effective when the ultracapacitor packs are in parallel with power pickups

Another aspect of the invention involves an electrically powered rail propulsion vehicle for bridging a gap in an external electrical power supply line without stalling. The electrically powered rail propulsion vehicle includes: one or more power pick ups configured to contact the external electrical power supply line for receiving external power; one or more ultracapacitor packs; one or more electric propulsion motors configured to receive electric power and propel the electrically powered rail propulsion vehicle; and one or more computer systems configured to cause electric power to be supplied from the one or more ultracapacitor packs to the one or more electric propulsion motors to propel the electrically powered rail propulsion vehicle through the gap in the external electrical power supply line without stalling if a gap in the external electrical power supply line is determined to occur.

Another aspect of the invention involves charging the one or more ultracapacitor packs through regeneration, or recaptured kinetic energy, typically associated with braking.

### BRIEF DESCRIPTION OF THE DRAWINGS

The accompanying drawings, which are incorporated in and form a part of this specification, illustrate embodiments of the invention and together with the description, serve to explain the principles of this invention.

FIG. 1 is a block diagram depicting an embodiment of a dual-mode locomotive incorporating certain aspects of the invention.

FIG. 2 is a block diagram depicting an embodiment of an electrically powered light rail commuter car or electric street car incorporating certain aspects of the invention.

FIG. 3 is a block diagram illustrating an exemplary computer system that may be used in connection with the various embodiments described herein.

### DETAILED DESCRIPTION OF A PREFERRED EMBODIMENT

Embodiments of electrically powered rail propulsion vehicles incorporating systems and methods directed toward overcoming problems associated with “gap jumping” will be described. Examples of electrically powered rail propulsion vehicles include, but not by way of limitation, dual-mode locomotives, electric street cars, and electrically powered light rail commuter cars. As used herein, “gap jumping” refers to bridging the sections of a rail line where gaps, gaplets, or phase breaks exist in an external electrical power supply. Examples of an external electrical power supply include, but not by way of limitation, a third rail and an overhead catenary power system. Additionally, it is understood that certain aspects of the features claimed may be combined in a single unit, or separated into multiple units.

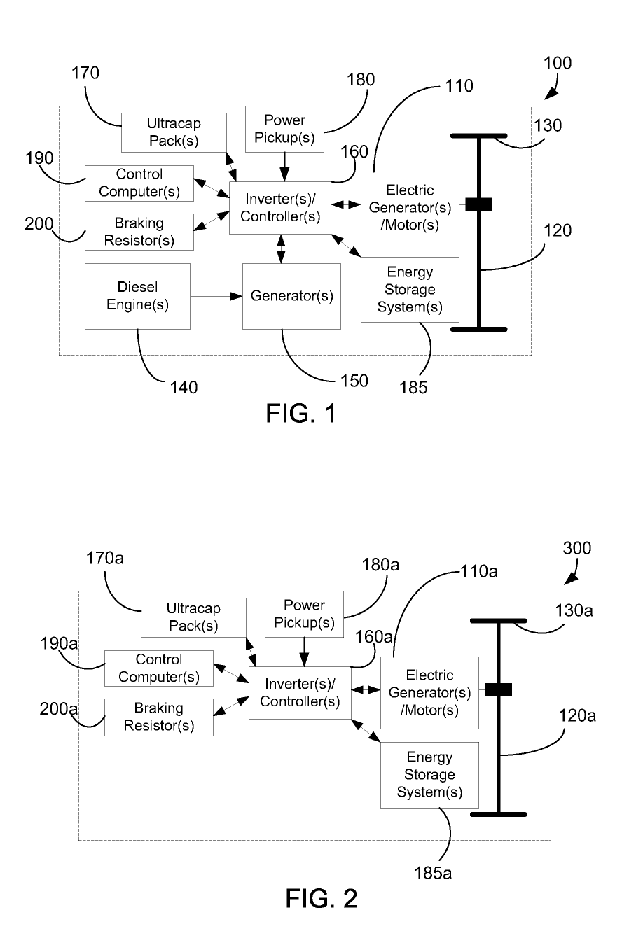

Referring to FIG. 1, depicted is a block diagram of an embodiment of a dual-mode locomotive 100 incorporating certain aspects of the invention, further described below. The dual-mode locomotive 100 includes one or more electric propulsion motors/generators 110 coupled to one or more axles 120 for driving the locomotive drive wheels 130. One or more diesel engine(s) 140 power one or more generator(s) 150 that supply electric power through one or more inverters/controllers 160 for powering the electric propulsion motor(s)/generator(s) 110. Although not shown, the locomotive 100 includes an onboard diesel fuel tank for supplying fuel to the diesel engine(s) 140.

The dual-mode locomotive 100 includes one or more ultracapacitor pack(s) 170 supplying electric power through one or more inverters/controllers 160 for powering the electric propulsion motor(s)/generator(s) 110. One or more power pickup(s) 180 (e.g., third rail shoegear assembly) contact an external power line (e.g., third rail) supply power through one or more inverters/controllers 160 for powering the electric propulsion motor(s)/generator(s) 110. One or more energy storage system(s) 185 such as one or more, or a combination of one or more, of: ultracapacitor pack(s), battery/battery pack(s) (e.g., nickel metal hydride (NiMH)), or flywheel(s) for receiving and storing energy, and/for supplying power to the train railcars. One or more braking resistor(s) 200 having the primary purpose of the dissipating excess deceleration braking regeneration energy from the electric generator(s)/motor(s) 110 during locomotive deceleration, dissipate the excess energy as heat. One or more control computers 190 control power flow to/from the electric propulsion motor(s)/generator(s) 110, the generator(s) 150, ultracapacitor packs(s) 170, braking resistors 200, energy storage system(s) 185, and/or the power pickup(s) 180.

The inverters/controllers 160 may include electronic devices such as GTO's (Gate Turn-off Thyristors) or IGBTs (Insulated Gate Bipolar Transistors) for controlling the switching actions in the inverters/controllers 160. In addition to powering the electric propulsion motor(s)/generator(s) 110, the inverters/controllers 160 may also supply power to one or more HEP (Head End Power) systems and/or to charge up ultracapacitor pack(s) 170.

As stated above, ultracapacitor pack(s) 170 and energy storage system(s) 185 may comprise discrete units or a single integrated system. In the alternate, energy storage system(s) 185 may consist of only ultracapacitor pack(s) 170 along with any associated hardware. Advantages of using an ultracapacitor pack(s) 170 include its high power capability, very high efficiency (typically 90% and better), wide temperature operation, and a life commensurate with that of the vehicle. Another advantage of the ultracapacitor pack(s) 170 is that they are currently capable of being charged with or discharging 400 amps over very short periods of time, followed by a cooling period. Ultracapacitor pack(s) 170 also act as an averaging device to reduce the spikes and dips in the system voltage as well as suppress electric arcs that would otherwise occur when a gap interrupts a high power current flow.

Ultracapacitor pack(s) 170 in the dual-mode locomotive 100, separately or integrated with energy storage system(s) 185, may be configured to supply electric power through one or more inverters/controllers 160 for powering the electric propulsion motor(s)/generator(s) 110, the one or more HEP (Head End Power) systems, or other electrical power needs of the rail vehicle. In an alternative embodiment, the one or more ultracapacitor pack(s) 170 are located in a train car other than the dual-mode locomotive 100.

Ultracapacitor pack(s) 170 may be also configured as appropriate to meet the electrical requirements of the system. For example, individual packs may be connected together in series to meet voltage requirements. Also, higher current capability is obtained by connecting additional packs in parallel. In a preferred embodiment, the one or more ultracapacitor pack(s) 170 include series connected individual cells to satisfy the drive system operating voltage requirement, a cell equalization and balancing network, a cooling system, voltage and temperature sensors, an optional fire suppression system, and a provision for a mounting structure and/or tie down straps.

Ultracapacitor pack(s) 170 cell equalization may be accomplished passively and/or actively. The cells may be passively equalized by, for example, connecting a resistor in parallel with each cell, thus creating a resistor divider. This resistor divider tends to equalize the voltage over time and discharges the pack overnight so that the balancing is “zeroed out” once a day. According to one embodiment, active balancing and equalization may also be required if an ultracapacitor pack is to maintain a stored charge over a number of days. Various types of active balancing and equalization will work if the reaction time is not much longer than the typical charge-recharge time cycle in operation. Typically, after balancing the charge and equalizing the voltage of each cell, an exemplary active technique “goes to sleep” without depleting the pack energy. As such, the leakage resistance of each cell is low enough to maintain a charge for couple weeks.

According to one embodiment, the energy storage system(s) 185 are charged by the power pickup(s) 180, the generator(s) 150, deceleration braking regeneration energy from the one or more electric motors/generators 110, and/or by an external power source such as an auxiliary engine generator. Likewise, in one or more embodiments, the ultracapacitor pack(s) 170 are charged by the power pickup(s) 180, the generator(s) 150, deceleration braking regeneration energy from the one or more electric motors/generators 110, excess energy from the energy storage system(s) 185, and/or pre-charged by an external power source.

However, unlike the energy storage system(s) 185, when comprised primarily of battery technology, the ultracapacitor pack(s) 170 retain a significant amount of energy while providing a medium that can be quickly recharged after being depleted of its stored energy. Thus an ultracapacitor's rate of charge insures it can be ready for the next event almost immediately after providing backup power from the prior event.

Pre-charging/charging an ultracapacitor pack to an operating voltage is accomplished through some type of current limiting power supply. According to one embodiment of the invention, pre-charging the ultracapacitor pack(s) 170 to an operating voltage may occur from an external power source (e.g., external plug-in device or external traction power source).

Another example of a current limiting power supply is the engine generator connected in series with one or more braking resistors to the ultracapacitor pack(s) as described fuller in U.S. Pat. No. 7,109,686, issued Sep. 19, 2006, and incorporated by reference herein as though set forth in full. One particular benefit of charging the ultracapacitor pack(s) 170 using deceleration braking regeneration occurs when dual-mode locomotive 100 enters a high traffic area that includes safety precautions such a terminal speed restriction. Rather than having to maintain a particular speed to coast through the gap, dual-mode locomotive 100 recaptures and stores its own kinetic energy as it enters the conductor-rail gap. Dual-mode locomotive 100 is then able to convert its stored energy back into propulsion energy.

In use, the dual-mode locomotive 100 typically uses either diesel electric or all electric power (i.e., electric power supplied through generator(s) 150 and power pickup(s) 180) to power the electric motor(s) 110 to turn the drive wheels 130 in pushing and/or pulling operations. The dual-mode locomotive 100 is configured to allow the diesel engine-generator(s) 150 and/or the power pickup(s) 180 to charge the ultracapacitor pack(s) 170. In addition, through braking regeneration, the motor(s)/generator(s) 110 of the locomotive 100 may charge the energy storage system(s) 185 and/or ultracapacitor pack(s) 170.

To reduce and/or eliminate “gap stalling” while “gap jumping” the control computer 190 detects that the power pickup(s) 180 have lost contact with a third rail (i.e., senses a gap), and immediately causes ultracapacitor pack(s) 170 to supply energy to electric motor(s)/generator(s) 110 to turn the drive wheels 130 until the control computer 190 determines that power pickup(s) 180 have contacted a third rail for a sufficient, predetermined period of time.

By reducing and/or eliminating delay in supplying energy from ultracapacitor pack(s) 170 loss of inertia is minimized, spikes and dips in the system voltage are reduced, and electric arcing is suppressed. According to one embodiment, control computer 190 electrically couples ultracapacitor pack(s) 170 to electric motor(s)/generator(s) 110 through switching. According to another embodiment, ultracapacitor pack(s) 170 are continuously electrically coupled in parallel with the one or more power pickup(s) 180 and the determining if a gap in the external electrical power supply line condition occurs happens automatically due to the continuous parallel connection.

In applications where a gap is too long for the ultracapacitor pack(s) 170 to supply enough power to propel the dual-mode locomotive 100 through the entire gap, and kicker rails exist, the ultracapacitor pack(s) 170 also provide additional viable power storage units for traction applications for the dual-mode locomotive 100. In particular, the ultracapacitor pack(s) 170 hold the locomotive 100 in a pre-charged state of readiness. This permits rapid propulsion application from the kicker rails and a real boost to conserve the momentum. Thus, even if the energy storage potential of the ultracapacitor pack(s) 170 is insufficient to power the locomotive 100 directly for a given gap distance, the ultracapacitor pack(s) 170 maintain the locomotive propulsion system in a state of readiness for kicker rails to “do their job” and maintain some momentum through long gaps.

Application of the above embodiments may reduce or even eliminate the effect of gaps in a particular rail system. Accordingly, dual-mode locomotive 100 incorporating the above teachings eliminates or reduces the need for an extra locomotive in order to bridge gaplets. Dual-mode locomotive 100 also reduces the risk of gapping/stalling, and the intangible losses that come from the resultant delay and the ripple effect it has on other train movements would be avoided.

Referring to FIG. 2, an embodiment of an electrically powered light rail commuter car or electric street car (“electric car”) 300 that is directed toward overcoming the problems with “gap jumping” (e.g., “phase break”) of an overhead catenary system will be described. Similar elements in the electric car 300 to those in the dual-mode locomotive 100 are described with like reference numbers, but with an “a” suffix. The electric car 300 is generally similar to the dual-mode locomotive 100 described above, except the electric car 300 does not include a diesel fuel supply, engine 140, and generator 150. Otherwise, the electric car 300 is similar to the dual-mode locomotive 100 in structure and function.

During a “phase break” of an overhead catenary system, where the overhead electrical power pickup 180a of the electric car 300 includes a gap and the electric car 300 experiences a power interruption (e.g., at intersections where overhead catenary electric supply wires limit the vehicle heights of the crossing streets or transitioning in and out of a garage area), to prevent “phase break” stalling, similar to dual-mode locomotive 100 described above, the control computer 190a detects that the power pickup(s) 180a have lost contact with the overhead catenary system and immediately causes ultracapacitor pack(s) 170a to supply energy to electric motor(s)/generator(s) 110a to turn the drive wheels 130a until the control computer 190a determines that power pickup(s) 180a have contacted the overhead catenary system for a sufficient, predetermined period of time. Thus, the onboard ultracapacitor pack 170a powers the electric car 300 across the street or other gap in the overhead catenary system to the next overhead catenary pickup.

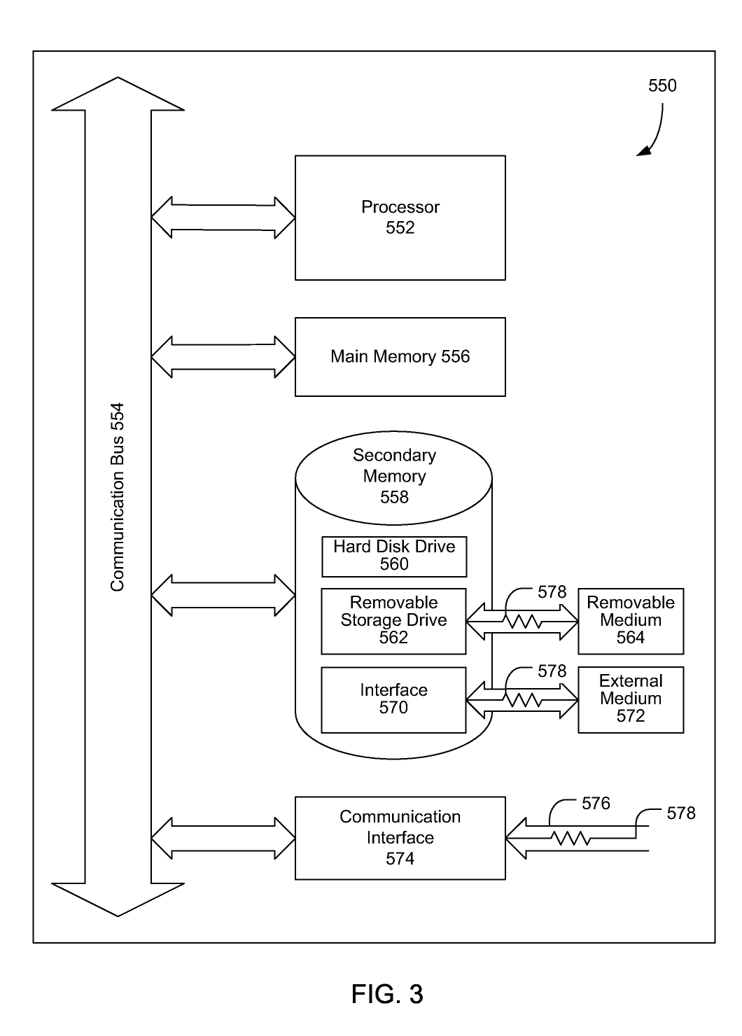

FIG. 3 is a block diagram illustrating an exemplary computer system 550 that may be used in connection with the various embodiments described herein. For example, the computer system 550 (or various components or combinations of components of the computer system 550) may be used in conjunction with the control computers, controllers, or to control the functions described herein. However, other computer systems and/or architectures may be used, as will be clear to those skilled in the art.

The computer system 550 preferably includes one or more processors, such as processor 552. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 552.

The processor 552 is preferably connected to a communication bus 554. The communication bus 554 may include a data channel for facilitating information transfer between storage and other peripheral components of the computer system 550. The communication bus 554 further may provide a set of signals used for communication with the processor 552, including a data bus, address bus, and control bus (not shown). The communication bus 554 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

Computer system 550 preferably includes a main memory 556 and may also include a secondary memory 558. The main memory 556 provides storage of instructions and data for programs executing on the processor 552. The main memory 556 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 558 may optionally include a hard disk drive 560 and/or a removable storage drive 562, for example a floppy disk drive, a magnetic tape drive, a compact disc (“CD”) drive, a digital versatile disc (“DVD”) drive, etc. The removable storage drive 562 reads from and/or writes to a removable storage medium 564 in a well-known manner. Removable storage medium 564 may be, for example, a floppy disk, magnetic tape, CD, DVD, etc.

The removable storage medium 564 is preferably a computer readable medium having stored thereon computer executable code (i.e., software) and/or data. The computer software or data stored on the removable storage medium 564 is read into the computer system 550 as electrical communication signals 578.

In alternative embodiments, secondary memory 558 may include other similar means for allowing computer programs or other data or instructions to be loaded into the computer system 550. Such means may include, for example, an external storage medium 572 and an interface 570. Examples of external storage medium 572 may include an external hard disk drive or an external optical drive, or and external magneto-optical drive.

Other examples of secondary memory 558 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage units 572 and interfaces 570, which allow software and data to be transferred from the removable storage unit 572 to the computer system 550.

Computer system 550 may also include a communication interface 574. The communication interface 574 allows software and data to be transferred between computer system 550 and external devices (e.g. printers), networks, or information sources. For example, computer software or executable code may be transferred to computer system 550 from a network server via communication interface 574. Examples of communication interface 574 include a modem, a network interface card (“NIC”), a communications port, a PCMCIA slot and card, an infrared interface, and an IEEE 1394 fire-wire, just to name a few.

Communication interface 574 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 574 are generally in the form of electrical communication signals 578. These signals 578 are preferably provided to communication interface 574 via a communication channel 576. Communication channel 576 carries signals 578 and can be implemented using a variety of wired or wireless communication means including wire or cable, fiber optics, conventional phone line, cellular phone link, wireless data communication link, radio frequency (RF) link, or infrared link, just to name a few.

Computer executable code (i.e., computer programs or software) is stored in the main memory 556 and/or the secondary memory 558. Computer programs can also be received via communication interface 574 and stored in the main memory 556 and/or the secondary memory 558. Such computer programs, when executed, enable the computer system 550 to perform the various functions of the present invention as previously described.

In this description, the term “computer readable medium” is used to refer to any media used to provide computer executable code (e.g., software and computer programs) to the computer system 550. Examples of these media include main memory 556, secondary memory 558 (including hard disk drive 560, removable storage medium 564, and external storage medium 572), and any peripheral device communicatively coupled with communication interface 574 (including a network information server or other network device). These computer readable mediums are means for providing executable code, programming instructions, and software to the computer system 550.

In an embodiment that is implemented using software, the software may be stored on a computer readable medium and loaded into computer system 550 by way of removable storage drive 562, interface 570, or communication interface 574. In such an embodiment, the software is loaded into the computer system 550 in the form of electrical communication signals 578. The software, when executed by the processor 552, preferably causes the processor 552 to perform the inventive features and functions previously described herein.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

What is claimed is:

1. A method of providing electric traction power to an electrically powered rail propulsion vehicle crossing over external electric traction power gap, the electrically powered rail propulsion vehicle including a power pickup configured to contact an external electric traction power supply and an electric motor configured to receive electric traction power, the method comprising:
detecting a loss of external electric traction power;
supplying electric traction power to the electric motor from an energy storage device located onboard the electrically powered rail propulsion vehicle, the energy storage device comprising an ultracapacitor pack.

2. The method of claim 1, wherein the detecting the loss of external traction power comprises sensing that the power pickup has lost contact with the external electric traction power supply.

3. The method of claim 2, wherein the ultracapacitor pack is electrically coupled in parallel with the power pickup, and,
wherein the supplying electric traction power to the electric motor comprises suppressing arcing from the power pickup having lost contact with the external electric traction power supply.

4. The method of claim 1, wherein the ultracapacitor pack is selectably coupled to the electric motor, and,
wherein the supplying electric traction power to the electric motor comprises selecting the ultracapacitor pack to be coupled with the electric motor.

5. The method of claim 4, further comprising:
determining a return of external electric traction power for a sufficient predetermined period of time; and
selecting the ultracapacitor pack to be decoupled from the electric motor.

6. The method of claim 1, further comprising charging the ultracapacitor pack with regenerated energy.

7. The method of claim 1, wherein the energy storage device further comprises at least one of a battery and a flywheel.

8. The method of claim 1, wherein the electrically powered rail propulsion vehicle is a dual-mode locomotive.

9. The method of claim 1, wherein the electrically powered rail propulsion vehicle is one of an electric street car and an electrically powered light rail commuter car.

10. The method of claim 1, wherein the ultracapacitor pack is continuously electrically coupled in parallel with the power pickup; and
wherein the detecting the loss of external electric traction power comprises the ultracapacitor pack automatically detecting the loss of external electric traction power due to its continuous parallel connection.

11. An electric traction power supply system for an electrically powered rail propulsion vehicle, the system comprising:
an electric motor configured to receive electric traction power and to propel the electrically powered rail propulsion vehicle using electric traction power;
a power pickup configured to contact an external electric traction power supply and supply external electric traction power to the electric motor from the external electric traction power supply;
an energy storage device comprising an ultracapacitor pack and configured to supply onboard electric traction power to the electric motor;
a control computer configured to determine that external traction power has been lost, and to cause onboard electric traction power to be supplied from the energy storage device to the electric motor upon the determination that external traction power has been lost.

12. The system of claim 11, wherein the determination that external traction power has been lost comprises sensing that the power pickup has lost contact with the external electric traction power supply.

13. The system of claim 12, wherein the ultracapacitor pack is electrically coupled in parallel with the power pickup, and is configured to suppress arcing from the power pickup having lost contact with the external electric traction power supply.

14. The system of claim 11, wherein the ultracapacitor pack is selectably coupled to the electric motor, and;
wherein control computer is further configured to select the ultracapacitor pack to be electrically coupled with the electric motor.

15. The system of claim 14, wherein the control computer is further configured to determine that external traction power has been restored for a sufficient predetermined period of time, and to select the ultracapacitor pack to be decoupled from the electric motor.

16. The system of claim 11, wherein the energy storage device further comprises at least one of a battery and a flywheel.

17. The system of claim 11, wherein the electrically powered rail propulsion vehicle is a dual-mode locomotive.

18. The system of claim 11, wherein the electrically powered rail propulsion vehicle is one of an electric street car and an electrically powered light rail commuter car.

19. The system of claim 11, further comprising a braking resistor selectably coupled to the electric motor and the ultracapacitor pack;
wherein the electric motor is further configured to supply regenerated energy to the ultracapacitor pack.

20. The system of claim 11, wherein the ultracapacitor pack is located in a located in a rail car other than the electrically powered rail propulsion vehicle.
